(19) United States
(12) Patent Application Publication
(10) Pub. No.: US 2026/0330014 A1
(43) Pub. Date: Oct. 22, 2026

(54) Hybrid IT/OT Agentic Security Operations System with Protocol-Aware Hybrid Knowledge Layer, Safety-Aware Temporal Risk Scoring, OT Purple Teaming Validation Engine, Closed-Loop Self-Learning and Tamper-Evident Governance

(71) Applicant: Zsolt Laszlo Kocsis, Erd (HU)

(72) Inventor: Zsolt Laszlo Kocsis, Erd (HU)

(21) Appl. No.: 19/714,694

(22) Filed: Jun. 22, 2026

(30) Foreign Application Priority Data
Jun. 20, 2026 (HU) P2600326

(51) Int. Cl. G06F 21/55

(52) U.S. Cl. CPC G06F 21/554; G06F 2221/034

(57) ABSTRACT

The present invention discloses a brownfield augmentation system for hybrid IT/OT environments that extends existing Security Operations Centers (SOCs) without replacement of core infrastructure. The system includes a multi-level AI Agent Layer that collaborates in real-time with an existing SIEM/SOAR platform serving as the single central orchestrator. Key technical innovations comprise: (1) an OT-Extended Hybrid Knowledge Layer supporting industrial protocols (Modbus, DNP 3, IEC 61850) with hybrid retrieval (vector embeddings+Purdue-extended Diamond Model graph+structured protocol data) and air-gapped persistence; (2) a Safety-Aware Temporal Actionable Operational Context (AOC) incorporating Safety Integrity Levels (SIL 1-4), Purdue Model levels, operational modes, and physical impact factors; (3) an Extended Victim-Aware Risk Scoring (VES/TRS) engine with SIL-weighted multipliers and physical consequence modeling; (4) an OT Purple Teaming Validation Engine for realistic IT-to-OT attack chain testing; (5) a Grounded Hypothesis Reinforcement Loop (GHRL) for closed-loop self-learning with SIL-scaled adjustments; and (6) a Tamper-Evident Protected Audit Repository (TPAR) with cryptographic hash chaining and Federated Promotion Mechanism for safe air-gapped rule transfer. The invention enables safe, incremental modernization of critical infrastructure while maintaining full regulatory compliance.

### CROSS-REFERENCE TO RELATED APPLICATIONS

This application claims priority benefit to PCT International Patent Application No. HU/P2600326 filed Jun. 20, 2026.

This application is a functional extension of PCT International Patent Application No. HU/P 2600319 filed on Jun. 16, 2026, which entered the United States as Application No. 19/714,401 on Jun. 20, 2026. The present application provides a specialized OT-relevant extension of the foundational brownfield Agentic SOC architecture.

### 3. Statement Regarding Federally Sponsored Research

Not applicable.

### 4. BACKGROUND OF THE INVENTION

This invention relates generally to the field of cybersecurity, and more particularly to AI-augmented Security Operations Centers (SOCs), hybrid IT/OT security architectures, brownfield SIEM/SOAR augmentation, protocol-aware threat intelligence systems, safety-aware risk scoring in operational technology (OT) environments, purple teaming validation, closed-loop self-learning mechanisms, and tamper-evident governance suitable for regulated, sovereign, and air-gapped deployments.

Traditional SOC tools struggle with OT protocol awareness, physical safety implications, brownfield integration constraints, and the need for measurable continuous improvement without disruptive platform replacement.

### 5. BRIEF SUMMARY OF THE INVENTION

The invention provides a synergistic hybrid IT/OT Agentic SOC augmentation architecture that layers advanced AI capabilities onto existing investments. The core design principle preserves the customer's existing SIEM/SOAR Platform (100) as the single central orchestrator while introducing a Multi-Level AI Agent Layer (200) (comprising L1 Triage Agent (201), L2 Decision Agent (202), and L3 Investigation Agent (203)) and specialized technical modules that operate in closed-loop collaboration.

The system integrates the following key components:
1. OT-Extended Hybrid Knowledge Layer (CTI Cache Module) (300)
2. Safety-Aware Temporal Actionable Operational Context (AOC) Cache (400)
3. Extended Victim-Aware Risk Scoring (VES/TRS) Engine (500) with SIL weighting
4. OT Purple Teaming Validation Engine (600)
5. Grounded Hypothesis Reinforcement Loop (GHRL) (700)
6. Tamper-Evident Protected Audit Repository (TPAR) (800) with air-gapped capabilities and Federated Promotion Mechanism (820) supported by Air Gap Barriers & Secure Sync Protocol (900)

All major data flows and component interactions are shown in FIG. 8, demonstrating real-time collaboration between the Existing SOC Infrastructure Layer (100), the Multi-Level AI Agent Layer (200), the core technical modules (300-800), and human analysts via Enhanced Decision Cards (210) routed through the SIEM/SOAR Platform (100) as the single central orchestrator.

This architecture enables safe, incremental modernization of hybrid IT/OT critical infrastructure while maintaining full governance, data sovereignty, and regulatory compliance (NIS2, DORA, IEC 62443, NIST SP 800-82, EU AI Act).

### 6. BRIEF DESCRIPTION OF THE DRAWINGS

The accompanying drawings, which are incorporated in and constitute a part of this specification, illustrate embodiments of the invention and, together with the Detailed Description, serve to explain the principles of the invention. Reference numerals follow the structured 100-series system defined herein.

FIG. 1—Overall Hybrid IT/OT Agentic SOC Architecture (100) is a high-level block diagram showing the integration of the Existing SOC Infrastructure Layer (100) (including SIEM/SOAR Platform (100) as central orchestrator, SCADA/HMI Systems (102), etc.) with the Multi-Level AI Agent Layer (200), OT-Extended Hybrid Knowledge Layer (300), Safety-Aware Temporal AOC Cache (400), Extended Victim-Aware Risk Scoring Engine (500), and Tamper-Evident Protected Audit Repository (TPAR) (800).

FIG. 2—OT-Extended Hybrid Knowledge Layer (CTI Cache Module) (300) is a diagram illustrating hybrid retrieval using Semantic Vector Embeddings (310), Purdue-Extended Diamond Model Graph (320), and Structured Protocol Data (330) (Modbus, DNP3, IEC 61850), with persistent caching (350) for air-gapped OT operation.

FIG. 3—Safety-Aware Temporal AOC Cache (400) and Extended Risk Scoring (VES/TRS) (500) is a flowchart showing OT-specific context dimensions including Purdue Model Levels (410), Safety Integrity Levels (SIL 1-4) (420), operational modes and physical impact factors (430), temporal validity and quality scoring (440), and their influence on dynamic risk scoring in the Extended Victim-Aware Risk Scoring Engine (500).

FIG. 4—OT Purple Teaming Validation Engine (600) is a diagram depicting the isolated test environment with Adversary Emulation Framework (610), SCADA/HMI Targets & Protocol Simulators (620), and closed-loop feedback to the Grounded Hypothesis Reinforcement Loop (GHRL) (700) and SIEM/SOAR Platform (100).

FIG. 5—OT-Enhanced Grounded Hypothesis Reinforcement Loop (GHRL) (700) is a diagram showing IT-to-OT attack execution, detection via the SIEM/SOAR Platform (100), feedback processing, weight adjustment, and rule promotion via the Federated Promotion Mechanism (820).

FIG. 6—Tamper-Evident TPAR Logging for Hybrid IT/OT Events (800) is an illustration of OT-specific event types being immutably recorded with Cryptographic Hash Chaining (SHA-256) (810) and LLM-assisted analysis in the Tamper-Evident Protected Audit Repository (TPAR) (800).

FIG. 7—Air-Gapped Hybrid IT/OT Deployment Mode with Secure Sync Protocol (900) is an overview diagram of fully disconnected operation with persistent OT knowledge cache (350) and local purple teaming capabilities supported by the Air Gap Barriers & Secure Sync Protocol (900).

FIG. 8—Overall Component Interaction and Data Flow in Multi-Level AI Agent Layer (200) is a high-level data flow and component interaction diagram showing how the six core modules (300-800) interact in real time within the Multi-Level AI Agent Layer (200) and with the Existing SIEM/SOAR Platform (100) serving as the single central orchestrator.

### 7. DETAILED DESCRIPTION OF THE INVENTION

### 7.1 Reference Numeral System

For clarity and consistency, the present specification and the accompanying drawings employ a structured 100-series reference numeral convention. The components are grouped by functional layer as follows:
100 Series: Existing SOC Infrastructure Layer (Central Orchestrator)
200 Series: Multi-Level AI Agent Layer
300 Series: OT-Extended Hybrid Knowledge Layer (CTI Cache Module)
400 Series: Safety-Aware Temporal Actionable Operational Context (AOC) Cache
500 Series: Extended Victim-Aware Risk Scoring Engine (VES/TRS)
600 Series: OT Purple Teaming Validation Engine
700 Series: Grounded Hypothesis Reinforcement Loop (GHRL)
800 Series: Tamper-Evident Protected Audit Repository (TPAR)
900 Series: Air Gap Barriers, Federated Promotion & Sync Protocol

The present invention is implemented as a three-host brownfield architecture specifically designed to augment—rather than replace—existing Security Operations Center (SOC) infrastructure in hybrid IT/OT environments. This architecture minimizes operational risk, protects prior capital investments in SIEM/SOAR platforms, and enables incremental modernization while maintaining full governance, data sovereignty, and regulatory compliance (NIS2, DORA, IEC 62443, NIST SP 800-82, EU AI Act).

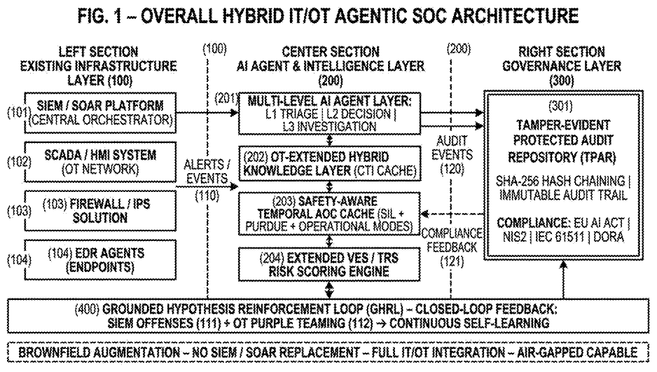

### 7.2 System Architecture Overview (FIG. 1)

As illustrated in FIG. 1, the system consists of a three-host brownfield architecture specifically designed to augment—rather than replace—existing Security Operations Center (SOC) infrastructure in hybrid IT/OT environments. This architecture minimizes operational risk, protects prior capital investments in the SIEM/SOAR Platform (100), and enables incremental modernization while maintaining full governance, data sovereignty, and regulatory compliance (NIS2, DORA, IEC 62443, NIST SP 800-82, EU AI Act).

The system comprises three logical hosts:
Host 2 (100—Existing SOC Infrastructure Layer): Contains the customer's existing SIEM/SOAR Platform (100). The existing SIEM/SOAR Platform (100) continues to serve as the single Central Orchestrator for all automated response actions. This is a fundamental design principle of the invention. Key elements include SIEM/SOAR Alerts and Offenses (101), SCADA/HMI Systems (102), Firewall/IPS Solutions (103), and EDR/Endpoint Agents (104).
Host 3 (200—Multi-Level AI Agent & Intelligence Layer): Hosts the Multi-Level AI Agent Layer (200), which consists of a hierarchical multi-agent system with three specialized levels: ○L1 Triage Agent (201): Performs initial alert enrichment, 4D prompt analysis, and preliminary filtering. ○L2 Decision Agent (202): Computes business-aligned risk scores using the Extended Victim-Aware Risk Scoring Engine (VES/TRS) (500) and generates recommended actions. ○L3 Investigation Agent (203): Conducts deeper analysis, hypothesis generation, and tool usage in complex cases. All agents collaborate with human analysts through structured Enhanced Decision Cards (210) routed via the existing SIEM/SOAR Platform (100), enabling effective human-in-the-loop governance while allowing progressive automation. This layer also includes the core technical modules: OT-Extended Hybrid Knowledge Layer (300), Safety-Aware Temporal Actionable Operational Context (AOC) Cache (400), Extended Victim-Aware Risk Scoring Engine (500), Grounded Hypothesis Reinforcement Loop (GHRL) (700), and supporting services.
Host 1 (600—Isolated Test & Adversary Simulation Layer): Provides a completely isolated environment for safe development, red teaming, use case testing, and validation using the OT Purple Teaming Validation Engine (600).

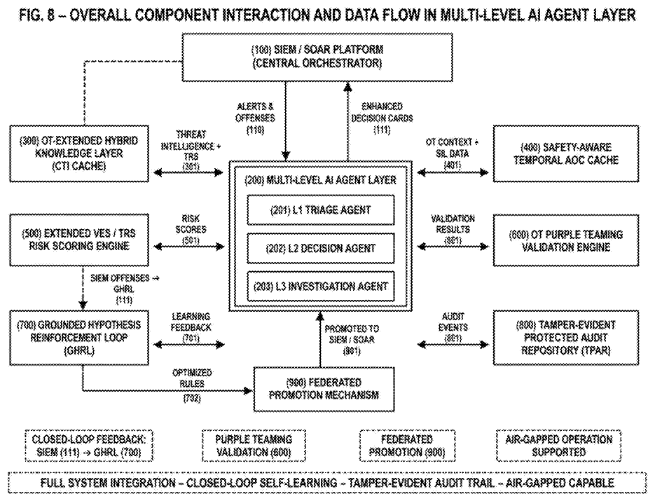

All major data flows and component interactions are shown in FIG. 8, illustrating real-time collaboration between the Existing SOC Infrastructure Layer (100), the Multi-Level AI Agent Layer (200), the technical modules (300-800), and the Air Gap Barriers & Secure Sync Protocol (900).

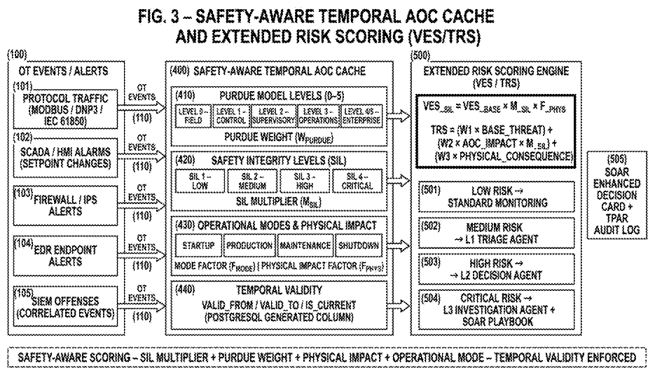

### 7.3 Event Enrichment and Safety-Aware Temporal Actionable Operational Context (AOC) Cache (FIG. 3) (400)

Security events originating from the existing SIEM/SOAR Platform (100) on Host 2 are first processed by the Safety-Aware Temporal Actionable Operational Context (AOC) Cache (400) (shown in FIG. 3).

The Safety-Aware Temporal AOC Cache (400) maintains business, operational, and safety context records with explicit temporal validity (valid_from/valid_to timestamps) and an automatically computed is_current flag. Each record is evaluated across multiple quality dimensions: freshness, accuracy, completeness, consistency, relevance, and source reliability.

OT-specific context dimensions include:
Purdue Model Levels (410) (0-5),
Safety Integrity Levels (SIL 1-4) (420),
operational modes (startup, production, maintenance, shutdown) and physical impact factors (430),
temporal validity and quality scoring (440).

Only high-quality, currently valid context from the Safety-Aware Temporal AOC Cache (400) is used for downstream decision-making. This ensures that risk calculations remain reliable even when some contextual sources are temporarily unavailable or stale. The cache supports automated ingestion from multiple sources, including asset management systems, HR databases, calendar systems, SCADA/HMI Systems (102), and standardized templates for tenant-specific data.

### 7.4 Extended Victim-Aware Framework and Risk Scoring (VES/TRS) (FIG. 3) (500)

Enriched events from the Safety-Aware Temporal AOC Cache (400) are then evaluated by the Extended Victim-Aware Framework implemented within the Extended Victim-Aware Risk Scoring Engine (VES/TRS) (500) (shown in FIG. 3).

This framework extends the classical Diamond Model by dynamically incorporating multiple victim context layers (Asset, Person/HR, Infrastructure, Business Goal, OT Safety Context) and computes real-time Victim Escalation Score (VES) (510) and Temporal Risk Score (TRS) (520).

Key formula (example): VES_SIL=VES_base×SIL_Multiplier×Physical_Impact_Factor

The weighting is adaptively adjusted in real time based on the quality scores provided by the Safety-Aware Temporal AOC Cache (400) and Purdue/SIL context (410, 420). For example, if safety-critical context data has low freshness or high physical impact potential, its influence on the final risk score in the Extended Victim-Aware Risk Scoring Engine (500) is automatically increased.

This adaptive, safety-and-quality-aware mechanism in the Extended Victim-Aware Risk Scoring Engine (VES/TRS) (500) is a key inventive feature that enables truly business-and safety-aligned prioritization far superior to traditional technical severity scoring.

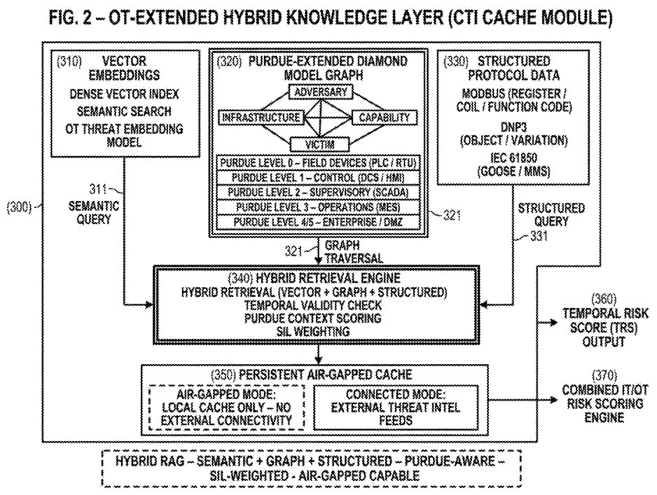

### 7.5 OT-Extended Hybrid Knowledge Layer (CTI Cache Module) (FIG. 2) (300)

The enriched event and risk scores from the Extended Victim-Aware Risk Scoring Engine (VES/TRS) (500) are passed to the OT-Extended Hybrid Knowledge Layer (CTI Cache Module) (300) (shown in FIG. 2).

This module performs sophisticated hybrid retrieval by combining:
Semantic Vector Embeddings (31l ),
Graph-based relationship analysis using the Purdue-Extended Diamond

Model Graph (320),
Structured temporal and protocol queries (Structured Protocol Data (330)) for industrial protocols including Modbus, DNP3, and IEC 61850.

This hybrid approach (enabled by the Hybrid Retrieval Engine (340)) enables accurate Temporal Risk Score (TRS) (520) calculation and provides rich contextual insights, even in fully air-gapped deployments where external threat intelligence is unavailable. The OT-Extended Hybrid Knowledge Layer (300) maintains an internal, updatable knowledge base that benefits from the Grounded Hypothesis Reinforcement Loop (GHRL) (700). Persistent caching (Persistent Air-Gapped Cache (350)) supports offline operation with periodic secure synchronization via the Air Gap Barriers & Secure Sync Protocol (900).

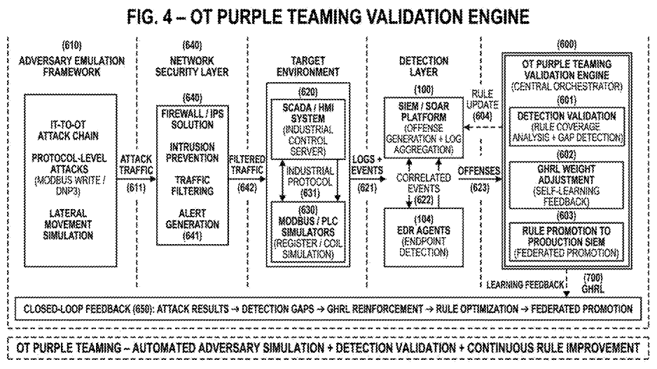

### 7.6 OT Purple Teaming Validation Engine (FIG. 4) (600)

New or modified detection logic and agent behaviors are developed and rigorously validated in the isolated Test Layer (Host 1) using the OT Purple Teaming Validation Engine (600) (shown in FIG. 4).

The engine executes realistic IT-to-OT attack chains against SCADA/HMI targets (102) and protocol simulators (Modbus/PLC) using the Adversary Emulation Framework (610) and SCADA/HMI & Protocol Simulators (620). It performs redundancy and overlap analysis, and generates optimized rules or intelligent extensions of existing capabilities. This significantly reduces rule bloat and improves overall detection quality while validating safety implications.

Validation results from the OT Purple Teaming Validation Engine (600) are provided as reliable ground truth to the Grounded Hypothesis Reinforcement Loop (GHRL) (700) and the SIEM/SOAR Platform (100).

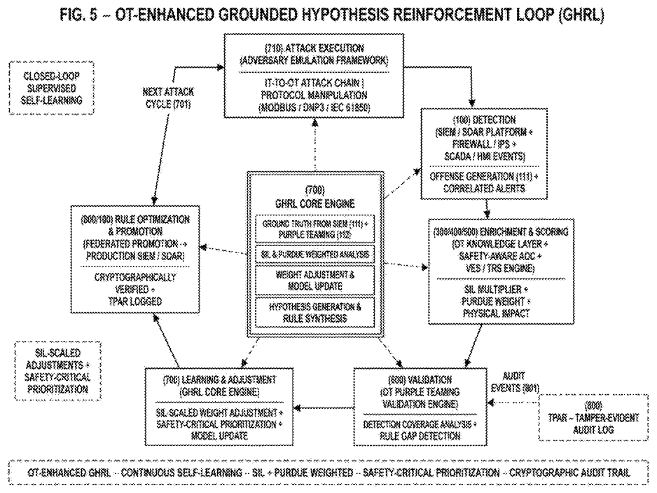

### 7.7 OT-Enhanced Grounded Hypothesis Reinforcement Loop (GHRL) (FIG. 5) (700)

Validated improvements from the OT Purple Teaming Validation Engine (600) are further refined through the OT-Enhanced Grounded Hypothesis Reinforcement Loop (GHRL) (700) (shown in FIG. 5).

The Grounded Hypothesis Reinforcement Loop (GHRL) (700) uses outputs from the OT-Extended Hybrid Knowledge Layer (300), Safety-Aware Temporal AOC Cache (400), Extended Victim-Aware Risk Scoring Engine (500), and OT Purple Teaming Validation Engine (600) as reliable ground truth for supervised self-learning.

New hypotheses are generated by the Multi-Level AI Agent Layer (200), tested in shadow mode or isolated environments, validated against real or synthetic data from the SIEM/SOAR Platform (100), and iteratively improved with SIL-scaled weight adjustments. Rule Gap detection from purple teaming exercises provides additional feedback signals to the GHRL Core Engine (700).

This closed-loop, safety-aware self-learning mechanism in the Grounded Hypothesis Reinforcement Loop (GHRL) (700) enables continuous, measurable improvement without hallucination or unsafe actions.

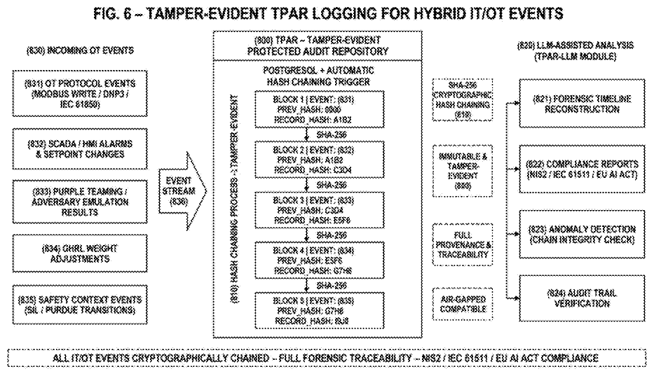

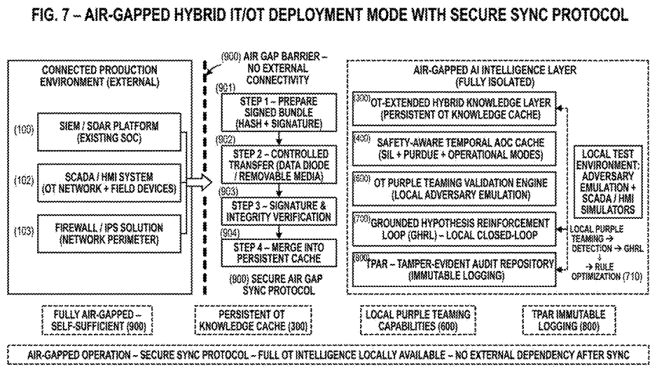

### 7.8 Tamper-Evident Protected Audit Repository (TPAR) and Federated Promotion Mechanism (FIG. 6 & FIG. 7) (800)

All critical events, decisions, and promotions are immutably recorded in the Tamper-Evident Protected Audit Repository (TPAR) (800) (shown in FIG. 6) using Cryptographic Hash Chaining (SHA-256) (810) and LLM-assisted analysis for forensic timelines.

Once validated and approved, use cases, optimized rules, and model updates are transferred to live production tenants via the Federated Promotion Mechanism (820) (part of the Tamper-Evident Protected Audit Repository (TPAR) (800), illustrated in FIG. 7). This mechanism includes cryptographic verification, full tamper-evident audit trails, controlled promotion protocols, and confirmation steps (e.g., appearance of expected offenses in the SIEM/SOAR Platform (100)) to ensure safety and regulatory compliance. The process is supported by the Air Gap Barriers & Secure Sync Protocol (900) for air-gapped environments.

### 7.9 Overall Closed-Loop Operation and Interactions (FIG. 8)

FIG. 8 provides a comprehensive view of real-time data flows and component interactions across the entire system. The Multi-Level AI Agent Layer (200) (L1-L3) works in continuous closed-loop collaboration with human operators and the Existing SIEM/SOAR Platform (100) serving as the single central orchestrator.

Low-risk decisions can be fully automated, while high-risk or complex cases escalate to human analysts with rich context and explainable recommendations via Enhanced Decision Cards (210).

The system operates as a perpetual closed-loop: monitoring feeds from the Existing SOC Infrastructure Layer (100) trigger detection, which activates evaluation and optimization in the Grounded Hypothesis Reinforcement Loop (GHRL) (700), followed by governed promotion via the Federated Promotion Mechanism (820) of the Tamper-Evident Protected Audit Repository (TPAR) (800). All actions maintain full provenance through the TPAR (800) for auditability, with support from the Air Gap Barriers & Secure Sync Protocol (900).

### 7.10 Deployment Modes and Additional Capabilities (FIG. 7)

As shown in FIG. 7, the system supports fully air-gapped operation and native multi-tenancy with tenant-isolated rule inventories, AOC data (400), and CTI Cache instances (300). The Air Gap Barriers & Secure Sync Protocol (900) enables secure, controlled transfer of knowledge and rules while maintaining physical isolation.

The architecture ensures high availability, explainability, safety-aware prioritization via the Extended Victim-Aware Risk Scoring Engine (500), and continuous measurable improvement through the Grounded Hypothesis Reinforcement Loop (GHRL) (700) while preserving the customer's existing SIEM/SOAR Platform (100) as the single point of orchestration and governance.

1. A brownfield hybrid IT/OT Agentic Security Operations augmentation system for augmenting an existing SIEM/SOAR Platform (100) that serves as the single central orchestrator comprising: a Multi-Level AI Agent Layer (200) configured to operate in real-time collaboration with the existing SIEM/SOAR Platform (100_; an OT-Extended Hybrid Knowledge Layer (CTI Cache Module) (300) configured to perform hybrid retrieval using vector embeddings, a Purdue Model-extended Diamond Model graph, and structured protocol data for industrial protocols including Modbus, DNP3, and IEC 61850 to support persistent caching for air-gapped operation; a Safety-Aware Temporal Actionable Operational Context (AOC) Cache (400) configured to maintain context records with explicit temporal validity periods, multi-dimensional quality scoring, Purdue Model levels, Safety Integrity Levels (SIL 1-4), operational modes, and physical impact factors; an Extended Victim-Aware Risk Scoring engine (500) configured to compute Victim Escalation Score (VES) and Temporal Risk Score (TRS) using adaptive SIL-weighted multipliers and physical consequence modeling; an OT Purple Teaming Validation Engine (600) configured to execute and validate IT-to-OT attack chains against SCADA/HMI targets and protocol simulators; a Grounded Hypothesis Reinforcement Loop (GHRL) (700) configured to perform closed-loop supervised self-learning with SIL-scaled weight adjustments using outputs from the OT Purple Teaming Validation Engine (600) and the Hybrid Knowledge Layer (300) as ground truth; and a Tamper-Evident Protected Audit Repository (TPAR) (800) with cryptographic hash chaining and a Federated Promotion Mechanism (820) configured to enable secure, auditable rule and knowledge transfer in air-gapped environments, whereby the system enables safe, incremental modernization of hybrid IT/OT critical infrastructure while maintaining regulatory compliance and data sovereignty.

2. The system of claim 1, wherein the Extended Victim-Aware Risk Scoring engine (500) computes a SIL-adjusted score according to the formula VES_SIL=VES_base×SIL_Multiplier×Physical_Impact_Factor, and wherein the weighting is adaptively adjusted in real time based on quality scores from the Safety-Aware Temporal AOC Cache (400).

3. The system of claim 1, wherein the Safety-Aware Temporal Actionable Operational Context (AOC) Cache (400) evaluates each context record across multiple quality dimensions including freshness, accuracy, completeness, consistency, relevance, and source reliability, and automatically determines an is_current status for use in risk calculations.

4. The system of claim 1, wherein the OT-Extended Hybrid Knowledge Layer (300) supports three-path hybrid retrieval comprising semantic vector search, graph traversal on the Purdue-extended Diamond Model, and structured protocol queries, enabling Temporal Risk Score (TRS) computation in both connected and fully air-gapped modes.

5. The system of claim 1, wherein the OT Purple Teaming Validation Engine (600) is configured to simulate full IT-to-OT attack chains including protocol-level manipulations (Modbus write, DNP3, IEC 61850) against SCADA/HMI systems and industrial protocol simulators, and to provide validation results as ground truth to the Grounded Hypothesis Reinforcement Loop (GHRL) (700).

6. The system of claim 1, wherein the Grounded Hypothesis Reinforcement Loop (GHRL) (700) performs iterative weight adjustment and model refinement using SIL-scaled feedback from purple teaming exercises and SIEM/SOAR offense correlation, while maintaining safety-critical prioritization.

7. The system of claim 1, wherein the Tamper-Evident Protected Audit Repository (TPAR) (800) records all OT-specific events, agent decisions, and promotions using cryptographic hash chaining, and supports LLM-assisted forensic timeline reconstruction while remaining fully functional in air-gapped deployments.

8. The system of claim 2, wherein the adaptive weighting of the Victim Escalation Score in the Extended Victim-Aware Risk Scoring engine (500) dynamically reduces the influence of low-quality context data and increases the weight of high physical-impact or high-SIL context in real time.

9. The system of claim 3, wherein the Safety-Aware Temporal Actionable Operational Context (AOC) Cache (400) supports automated ingestion from multiple sources including asset management systems, SCADA/HMI systems (102), and standardized templates, with automatic expiration handling based on validity periods.

10. The system of claim 4, wherein the OT-Extended Hybrid Knowledge Layer (300) maintains persistent local caching in air-gapped mode and supports secure synchronization of selected knowledge and rules via a controlled Air Gap Sync Protocol (900).

11. The system of claim 5, wherein the OT Purple Teaming Validation Engine (600) performs automated redundancy and overlap analysis between new detection logic and existing SIEM rules, and generates optimized, non-duplicative production rules or extensions.

12. The system of claim 6, wherein the Grounded Hypothesis Reinforcement Loop (GHRL) (700) incorporates Rule Gap detection from purple teaming exercises and shadow-mode validation against production data to refine agent behavior and detection logic without unsafe actions.

13. The system of claim 1, further comprising native multi-tenancy support with tenant-isolated rule inventories, AOC data stores (400), and CTI Cache instances (300), and automated tenant enrollment processes for integration of existing customer-owned SIEM/SOAR platforms (100).
